(19) United States
(12) Patent Application Publication
(10) Pub. No.: US 2002/0046219 A1
(43) Pub. Date: Apr. 18, 2002

(54) Web site system

(76) Inventor: Koyo Iida, Sizuoka (JP)

Correspondence Address: YOUNG & THOMPSON, 745 SOUTH 23RD STREET 2ND FLOOR, ARLINGTON, VA, 22202

(21) Appl. No.: 09/784,189

(22) Filed: Feb. 16, 2001

(30) Foreign Application Priority Data
Oct. 13, 2000 (JP) 2000-312746

(51) Int. Cl. G06F 17/21

(52) U.S. Cl. 707/501.1; 707/513

(57) ABSTRACT

A Web suite system freely sets data contents and their layout using an XML document, etc., and can be applied to a portable telephone and a PDA. For example, the layout and the contents on a Web site can be freely selected to generate a database using, for example, a computer language of an XML, etc. As a result, a site can be flexibly designed.

### BACKGROUND OF THE INVENTION

1. Field of the Invention

The present invention relates to a Web suite system for providing a Web suite system capable of designing a flexible site by freely selecting the layout and the contents of a Web site according to the contents and the configuration information generated in a database using a computer language such as Java, XML, etc.

2. Description of the Prior Art

Conventionally, a Web site has been designed using an HTML (hyper text markup language). The Web site designed using the HTML has been realized by setting the position, size, color, etc. of page data using a tag of the HTML, and distributing the contents, etc.

However, even when the XML is used, the page configuration information configuring page data and the contents cannot be freely incorporated into a database. In addition, a portable telephone and a PDA such as a mobile terminal, etc. cannot freely use a program generated using the description of the XML, the page configuration information in a database, and the contents.

### SUMMARY OF THE INVENTION

The present invention provides a Web suite system capable of freely setting the contents and the layout with a portable telephone and a PDA using the XML descriptions, the page configuration information, the contents, etc.

That is, the present invention can be attained by providing a Web suite system for performing a storing process of storing the contents and the page configuration information in a database; a page data generating process of generating a page data using the contents and the page configuration information stored in the database in the storing process; and a displaying process of displaying the page data generated in the page data generating process on a user terminal device.

As the above mentioned database, various applications can be used. For example, the contents can be expressed by characters, images, voice, binary codes, etc. The layout of the page configuration information can be freely designed. With the configuration, the contents and the layout can be dynamically designed. Therefore, using a Web browser, a form for supporting a data input can be freely combined with another, thereby interactively providing the contents.

Furthermore, the contents can be expressed by characters, images, voice, binary codes, etc. With the configuration, the Web suite system according to the present invention can use a larger volume of contents.

The above mentioned page data is generated based on the XML. Using the XML, various applications can be used, and a user-friendly page screen and a screen transition can be designed. Furthermore, a designed page can be immediately used.

In addition, since a database for storing information obtained by an application can be defined and an accessing method can be described in the above mentioned XML, the accumulated data can be freely extended.

### BRIEF DESCRIPTION OF THE DRAWINGS

FIG. 1 shows the system configuration of the Web suite system according to an embodiment of the present invention;

FIG. 2 shows the configuration of a server;

FIG. 3 shows the basic configuration of the Web suite;

FIG. 4 shows the practical configuration of the W S DATA;

FIG. 5 shows the process of the Web suite system;

FIG. 6 shows the process of the Web suite system;

FIG. 7 is a flowchart of the processes of the Web suite system according to an example of the present invention;

FIG. 8 shows a display example of an initial screen, and a display example of a login frame, a service information frame, a sign-up shift button, etc.;

FIG. 9 shows a display example of a sign-up item input screen, and shows an actual mail format;

FIG. 10 shows an example of a sign-up item input screen;

FIG. 11 shows a sign-up item confirmation screen;

FIG. 12 is a flowchart of a reminder process;

FIG. 13 shows a reminder input screen;

FIG. 14 shows a top screen exclusive for members;

FIG. 15 is a flowchart of a process of and after the top screen exclusive for members;

FIG. 16 shows the case of selecting an ‘address book’;

FIG. 17 shows an example of a process of changing the contents of the address book;

FIG. 18 is a flowchart of the contents changing process of the address book; and

FIG. 19 is a flowchart of the contents changing process of the address book.

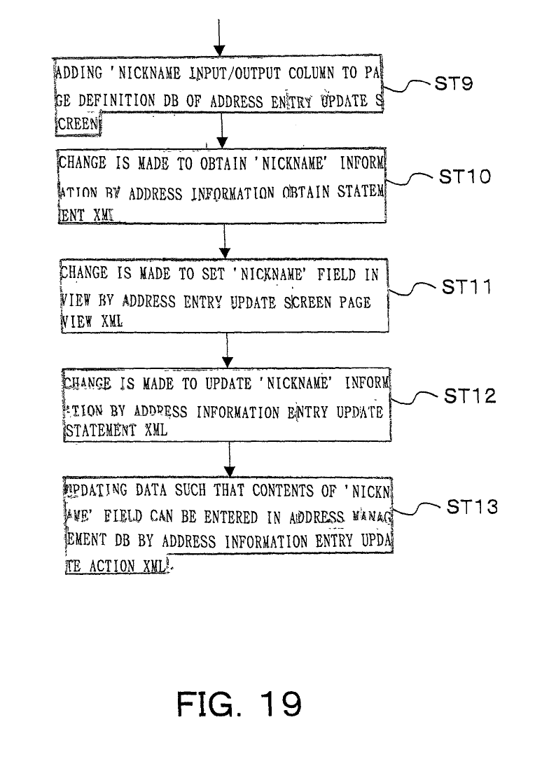

### DESCRIPTION OF THE PREFERRED EMBODIMENTS

The embodiments of the present invention are described below by referring to the attached drawings.

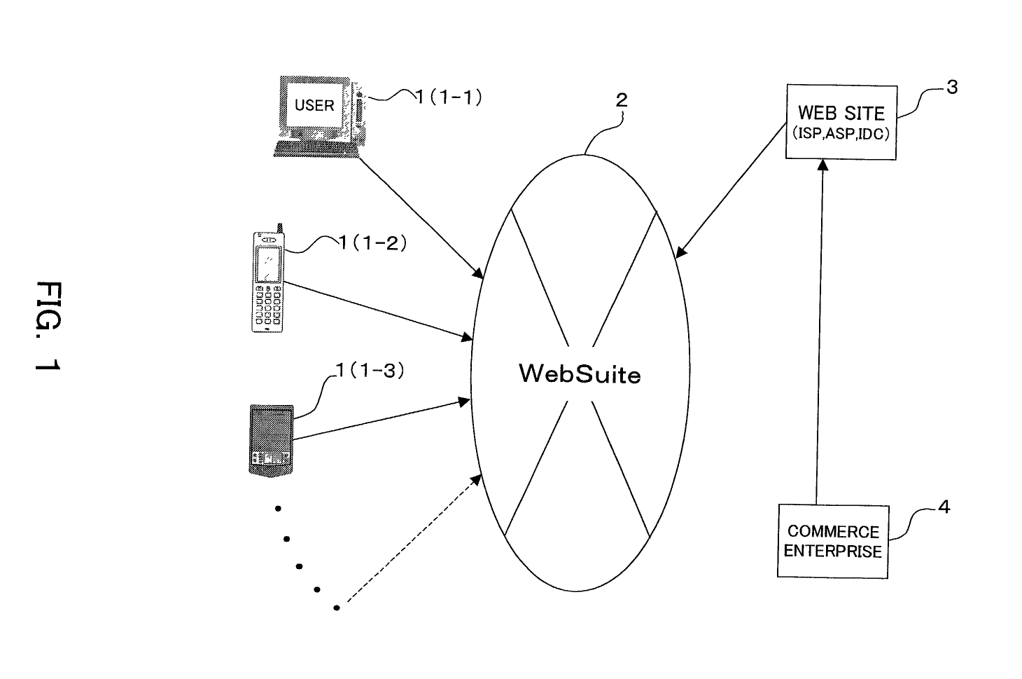

FIG. 1 shows the system configuration of the Web suite system according to an embodiment of the present invention. A terminal units 1 of a user can be connected to a Web site 3 through a Web suite 2, and various kinds of information can be distributed from a commerce enterprise 4 to the Web site 3. The terminal units 1 of the user comprises a personal computer, a portable telephone, and various mobile appliances. For example, they can be a personal computer 1-1, a portable telephone 1-2, and various mobile appliances 1-3, etc.

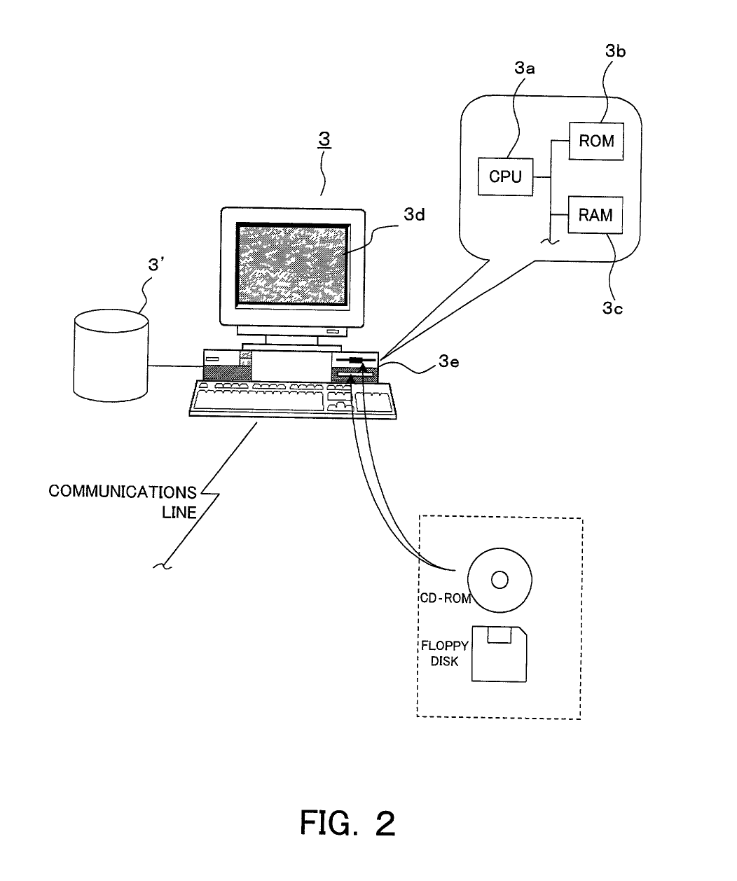

The Web site 3 has a server, and FIG. shows a type of server. The server comprises a CPU 3a, ROM 3b, RAM 3c, etc., and the CPU 3a performs a process according to the system program entered in the ROM 3b, accesses a database 3′ connected to the server, and transmits and receives data. A display 3d displays necessary information, and the information can be transmitted and received through a communications line. The system is controlled by the program stored in the ROM 3b, but a storage medium such as a floppy disk, CD-ROM, etc. can be provided for a media driver 3e mounted in the server as shown in FIG. 2 to read and use the program from the above mentioned storage media.

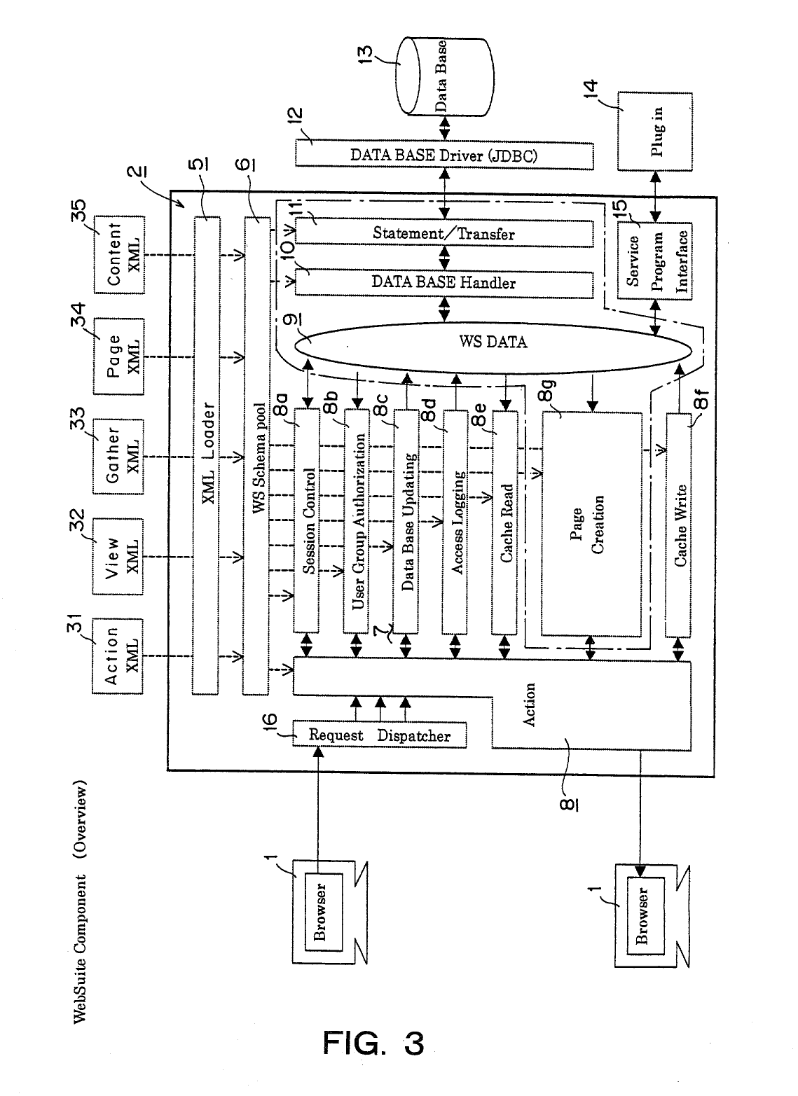

FIG. 3 shows the configuration of the Web suite 2. The Web suite 2 comprises an XML loader 5, a WS schema pool 6, an action unit 7, a WS data 9, a data base handler 10, a statement/transfer 11, and a service program interface 15. The action unit 7 performs a process at a request dispatcher 16 of the user 1.

The XML loader 5 analyzes a provided XML, and generates an integrated XML program. A provided XML document can be an action XML 31, a view XML 32, a gather XML 33, a page XML 34, and a contents XML 35, and contains a logic form, a schema, a character string, etc.

The WS schema pool 6 has the function of storing the XML information generated by the XML loader 5, generates a necessary XML document when the system according to the present embodiment is activated, and reads the document to the WS schema pool 6.

By the control of an action 8, the action unit 7 performs a session control process 8a, a user group authorization process 8b, a database updating process 8c, an access logging process 8d, a cache read process 8e, and a cache write process 8f. In each of the above mentioned processes, a user page is generated. For example, the database updating process 8c is a process performed when a database described later is updated, the access logging process 8d counts, for example, the number of accessing processes, the cache write process 8f caches, for example, the information read from a database, and the cache read process 8e reads cached data as necessary to generate a page.

In addition, the user group authorization process 8b controls a user group environment, and uses it when a group is set. The page generated in the above mentioned processes is generated in a page creation 8g, and is transmitted to the user terminal units 1 by the process of the action 8.

On the other hand, the WS data 9 is a format in which data can be processed by the action unit 7, and data is transmitted to and received from a database 13 through the data base handler 10, the statement/transfer 11, and a data base driver (JDBC) 12. There are a number of applications in the database 13, and the data base driver (JDBC) 12 accesses each application to read necessary data.

The WS data 9 contains layout information. For example, it contains the information (layout information) which cannot be replaced with existing pages and contents when an application is generated. The statement/transfer 11 contains an SQL used when the database 13 is searched, changed, deleted, etc., and changes the SQL using the searched database 13.

Furthermore, a plug in soft 14 can be used through the service program interface 15.

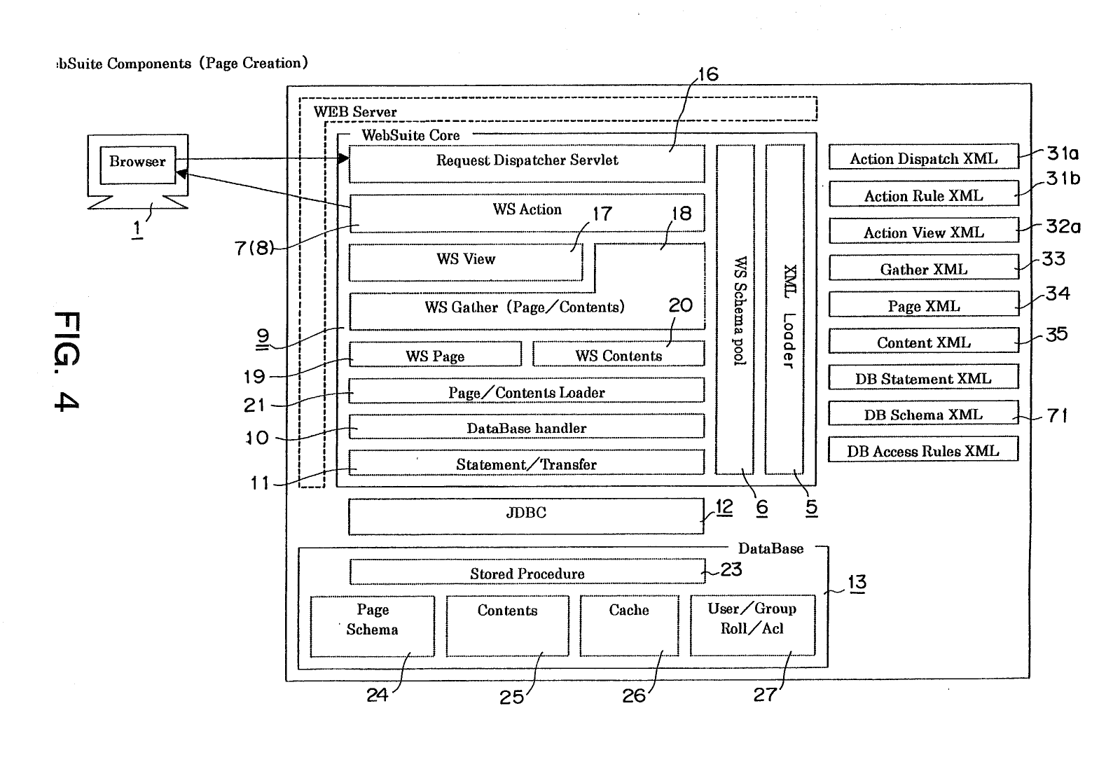

FIG. 4 practically shows the functions of the WS data 9, the data base handler 10, the statement/transfer 11, etc. with the above mentioned configuration.

The WS data 9 has the functions of a WS view 17, a WS gather 18, a WS page 19, a WS contents 20, and a page/contents loader 21. The WS gather 18 has the function of collecting frame information and contents information from the database 13, and the collected page information and contents information are displayed by the WS view 17. In addition, the WS page 19 collects the page information, and the WS contents 20 collects the contents information. The page/contents loader 21 collects the page information and the contents information actually through the data base handler 10.

The page information and the contents information are collected by the descriptions of the gather XML 33, the page XML 34, and the contents XML 35.

On the other hand, the database 13 contains the data structure including a stored procedure 23, a page schema 24, contents 25, cache 26, user/group roll/Ac1 27, etc.

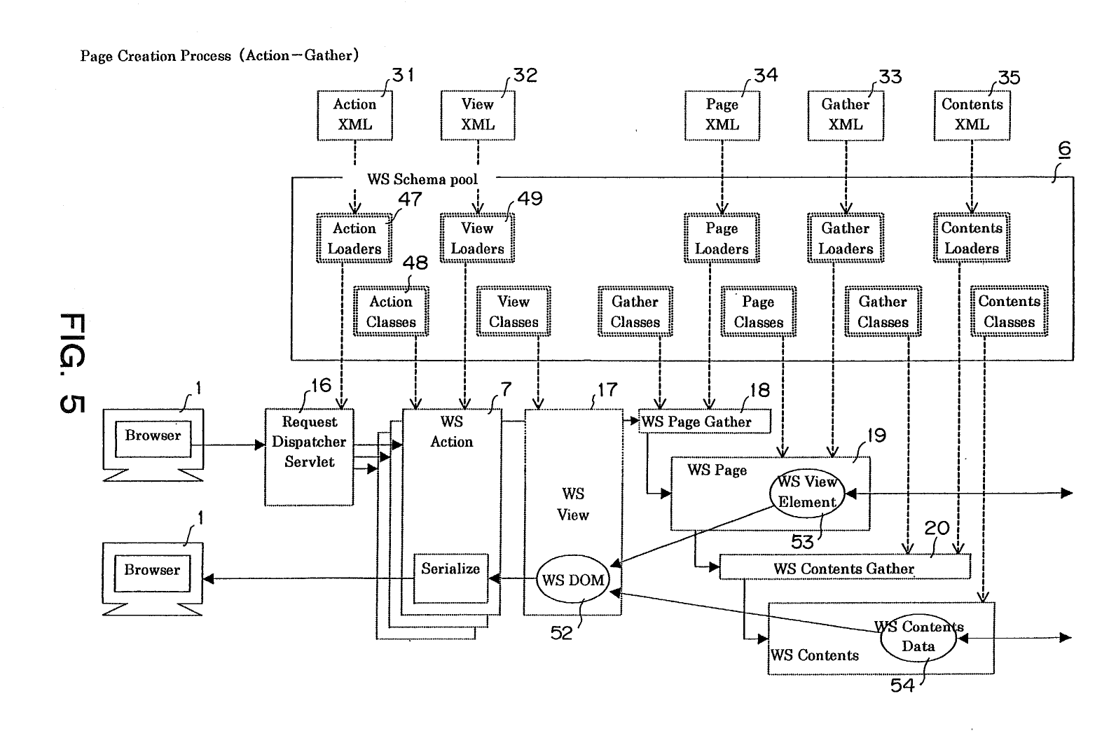

FIG. 5 shows in detail each of the above mentioned functions. In FIG. 5, the action XML 31 describes the contents of the instruction of the user, For example, it prescribes ‘a map is displayed when a predetermined button is pushed’, ‘a schedule of a specific person is displayed when a button is pushed’, etc. The view XML 32 is an XML document describing, for example, ‘where is the map displayed?’, ‘where is the schedule displayed?’, etc. The gather XML 33 (not shown in FIG. 5) is an XML document describing ‘in which range are maps collected?’, ‘in which range are schedules collected?’, etc. Furthermore, the page XML 34 is an XML document describing, for example, the layout of a page, and the contents XML 35 is a document describing an instruction to collect the contents information.

The above mentioned XML 31 through 35 are provided for the WS schema pool 6, drive a corresponding loader, and perform a process at a request of a user. For example, in the request dispatcher 16, action loaders 47 are activated according to the descriptions of the action XML 31, and specify an action to display a map by operating a user button, etc.

In addition, an action classes 48 is activated to activate the above mentioned WS action. Similarly, view loaders 49, etc. are driven by the descriptions of the corresponding view XML 32 and the page XML 34, and collect the necessary page information and contents information using the above mentioned WS view 17, the WS gather 18, the WS page 19, the WS contents 20, etc. A WS DOM 52 is a program for communication between an XML document and application data, classifies contents into each object to generate data to be processed by an application. A WS view element 53 is an element of a page. In the above mentioned schedule, elements can be ‘date and time’, ‘meeting’, ‘day of week’, etc. In map information, elements can be ‘place’, ‘hotel’, ‘restaurant’, etc.

A WS contents data 54 is practical contents (data). For example, in the above mentioned schedule, the contents in the above mentioned schedule can be ‘September 30’, ‘Saturday’, ‘meeting with Mr. xxx’, ‘October 3’, ‘Tuesday’, ‘meeting with Mr. yyy’, etc.

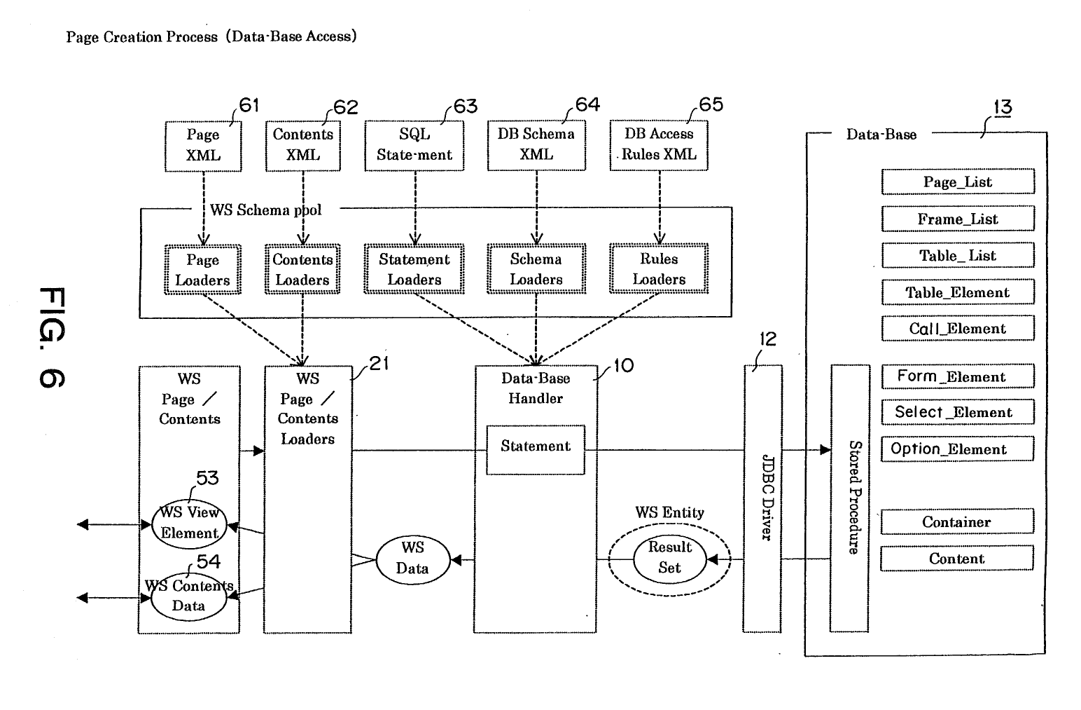

On the other hand, FIG. 6 shows the system configuration used when the database 13 is accessed. As in FIG. 5, a process is performed according to the information described in a page XML 61, a XML 62, an SQL statement 63, a database schema XML 64, and a database access rules XML 65, and the database 13 is accessed. Refer to FIG. 5 for the WS view element 53 and the WS contents data 54.

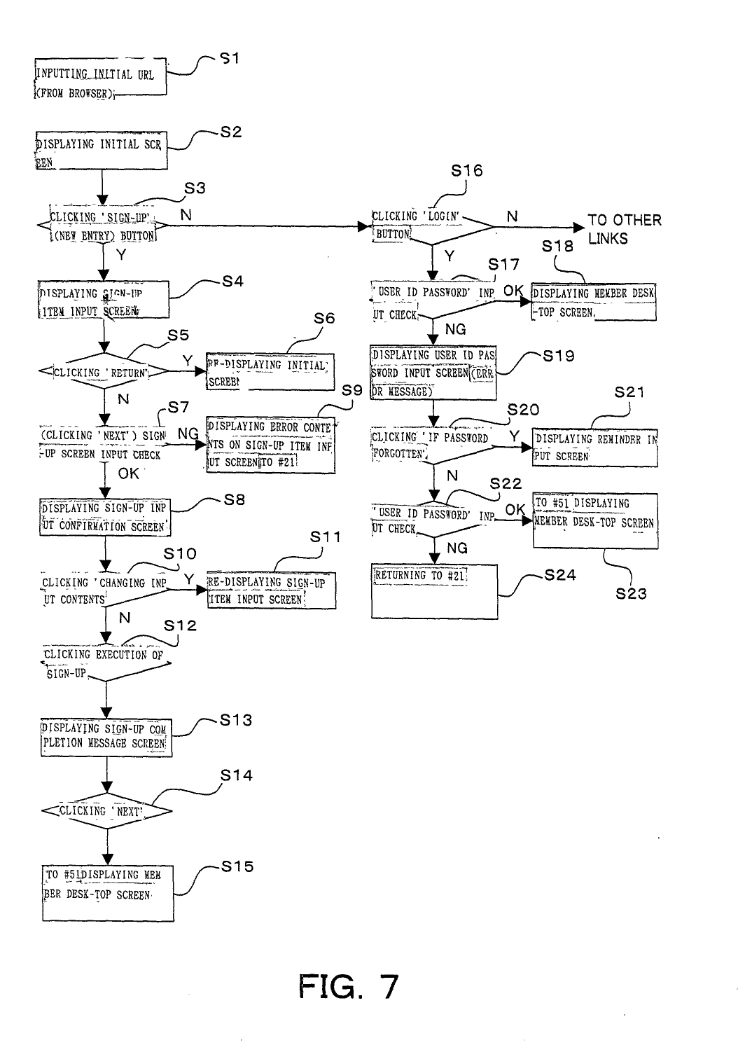

In the Web suite system with the above mentioned configuration, an entry process in the Web suite system according to an embodiment of the present invention is described first below. FIG. 7 is a flowchart showing the entry process.

First, the user operates his or her own personal computer, activates the Web browser, and input the URL of the Web site 3 of the present embodiment (step (hereinafter expressed as S) 1). By the input of the URL, the display data on the initial screen is transmitted from the Web site 3 to the user, and is displayed on the display of the user terminal appliances (S2).

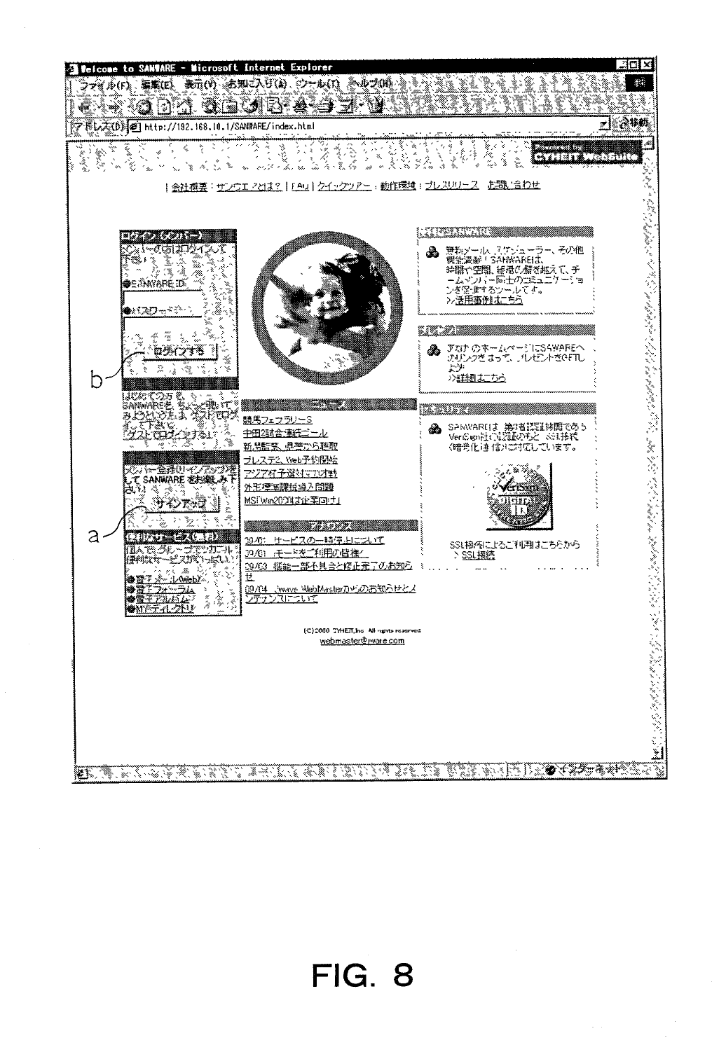

FIG. 8 shows an example of the display of the initial screen. A login frame, a service information frame, a sign-up shift button, etc. are displayed. If the user has not been entered in the present system, a ‘sign-up’ button is clicked (Y (yes) in S3). That is, a mouse, etc. is operated, and the position of the cursor is shifted to the position a shown in FIG. 8.

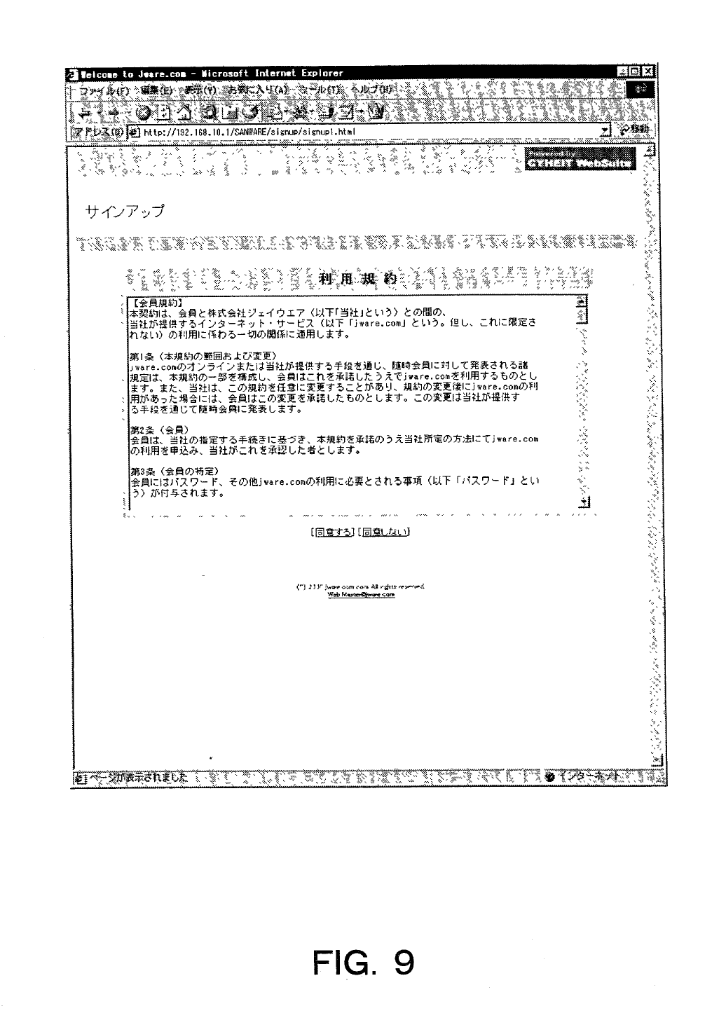

According to the above mentioned user instruction, a sign-up item input screen is transmitted from the Web site 3, and is displayed on the display unit of the terminal appliances (S4). FIG. 9 shows an example of the display of the sign-up item input screen. First, a use rules are displayed. When the user agrees with the use rules, he or she clicks a ‘agreement’ button. When the user does not agree with them, he or she clicks an ‘objection’ button.

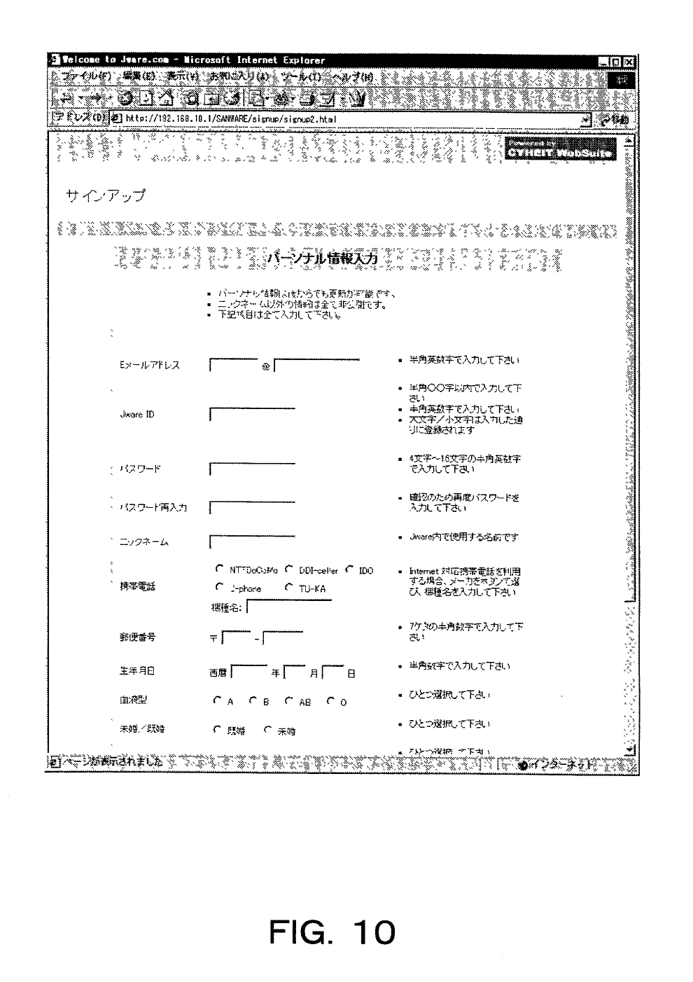

If the user clicks the ‘objection’ button (Y in S5), then control is returned to the above mentioned process (S2), and the initial screen is displayed on the display unit (S6). On the other hand, if the user agrees the use rules, then he or she clicks the agreement button to display the sign-up item input screen shown in FIG. 10 on the display unit. On the sign-up item input screen, various input items such as an e-mail address, a password, a nickname, the name of the model of a portable telephone, etc. are displayed, and the user inputs necessary information.

Then, an input sign-up item is checked (S7). If there are no problems, then the next sign-up item confirmation screen is displayed (Y in S7, S8). When an error is detected in the input check (N in S7), the sign-up item input screen is displayed (S9), and the input is corrected.

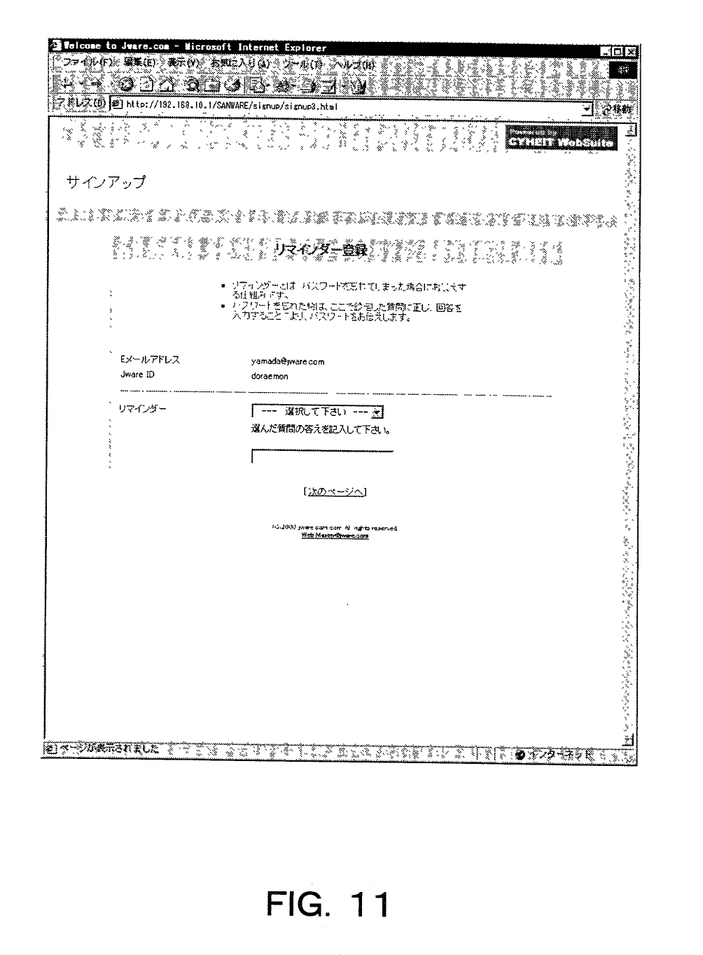

If there are no problems in the input check, then the sign-up item confirmation screen shown in FIG. 11 is displayed (S8). On the confirmation screen, the input information is displayed. If an e-mail address, a nickname, the name of the model of a portable telephone number, etc. are not correct, then an ‘input contents change’ button is clicked, and the sign-up input screen is re-displayed Y in S10, S11). On the other hand, if there is no error in the input information, a ‘sign-up execution’ button is clicked, and an instruction to perform the sign-up process is output (S12).

When the sign-up process is completed on the Web site 3, a sign-up completion notification is displayed on the display (S13). On the screen, When the user clicks on ‘next step’, a top screen exclusive for the members is displayed (S14, S15).

On the other hand, the user who has already been entered in the present system answers ‘NO’ (N in S3) in the above mentioned determination, inputs the ‘entered ID number’ and the ‘password’ on the initial screen shown in FIG. 8, and checks the ‘login’ button (position b shown in FIG. 8) (Y in S16). In this process, the ‘entered ID number’ and the ‘password’ are transmitted to the Web site 3. and the ‘entered ID number’ and the ‘password’ are checked (S17). If the above mentioned input does not refer to the check of the ‘login’ button (N in S16), then another corresponding process is performed.

If there are no problems with the ‘entered ID number’ and the ‘password’, then the top screen exclusive for the members is displayed (OK in S17, S18). On the other hand, if there is an error in both or one of the ‘entered ID number’ and the ‘password’ (NG in S17), then the input screen for the ‘entered ID number’ and the ‘password’ is displayed, and an error message is displayed (S19).

When the user forgets the ‘password’, the display of ‘password forgotten’ not shown in the attached drawings is clicked to display a reminder input screen (Y in S20, S21). In this case, the ‘password’ can be confirmed by inputting predetermined information.

After an error message has been displayed, the Web site 3 checks the input ‘entered ID number’ and ‘password’. If there are no problems with them, the top screen exclusive for the members is displayed (OK in S22, S23). If there is any problem detected in the above mentioned check, then the input screen of the ‘entered ID number’ and the ‘password’ is displayed again (NG in S22, S24).

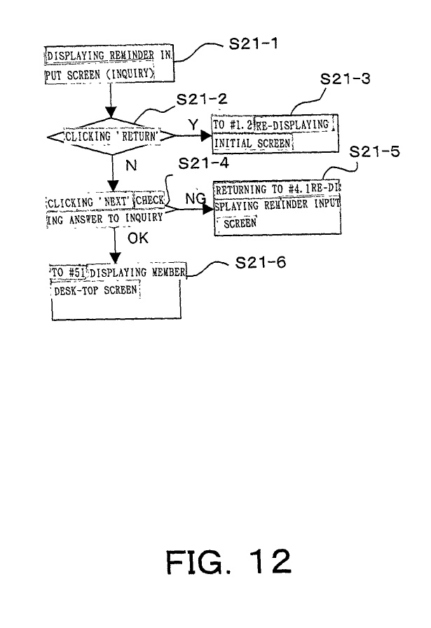

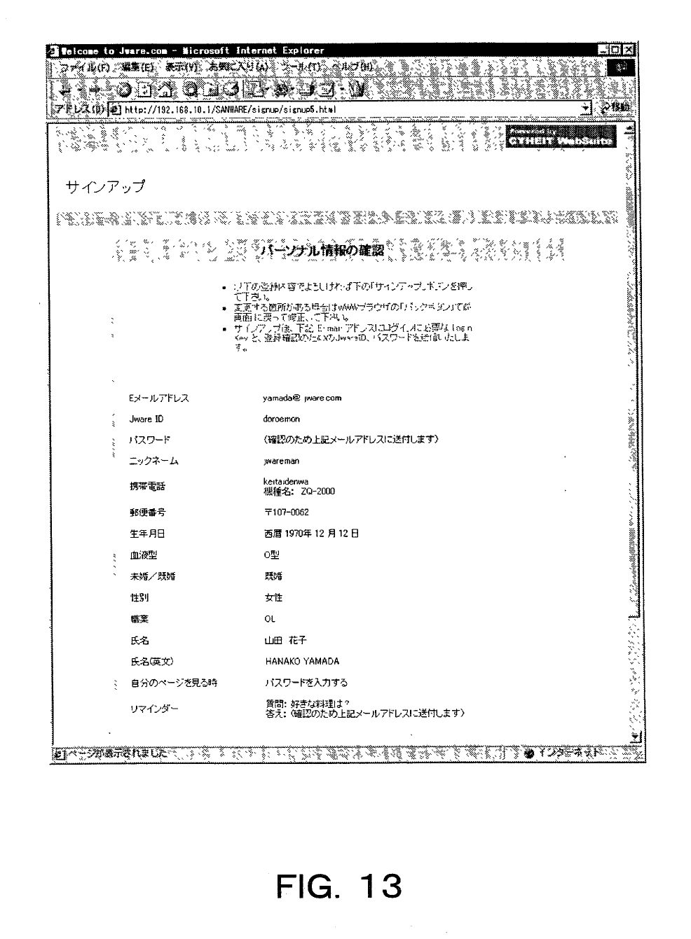

FIG. 12 is a flowchart of the above mentioned reminder process, and shows the reminder input screen (S21-1). FIG. 13 shows a reminder input screen in which data is input in a question-answer format. If there is no problems after checking the input data, control is passed to the top screen exclusive for the members (S21-4, S21-6). If there are problems with the data in the answers, the reminder input screen is displayed again to input again the data (S21-4, S21-5). When a ‘return’ button displayed on the screen is clicked, the above mentioned initial screen is displayed (S21-2, S21-3).

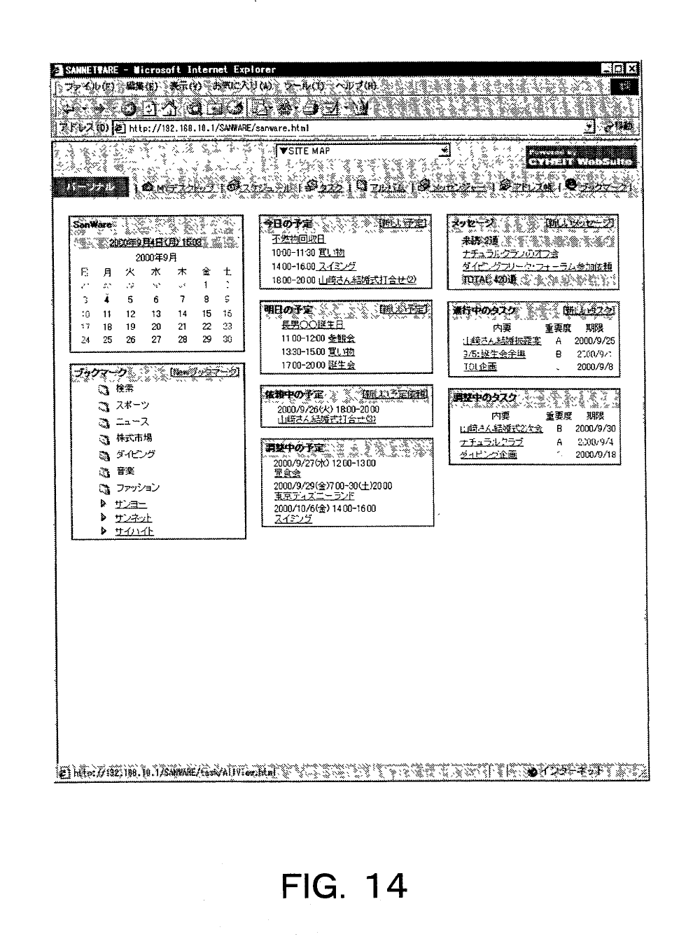

FIG. 14 is a top screen exclusive for the members on which menus such as ‘schedule’, ‘task’, ‘album’, etc. are displayed.

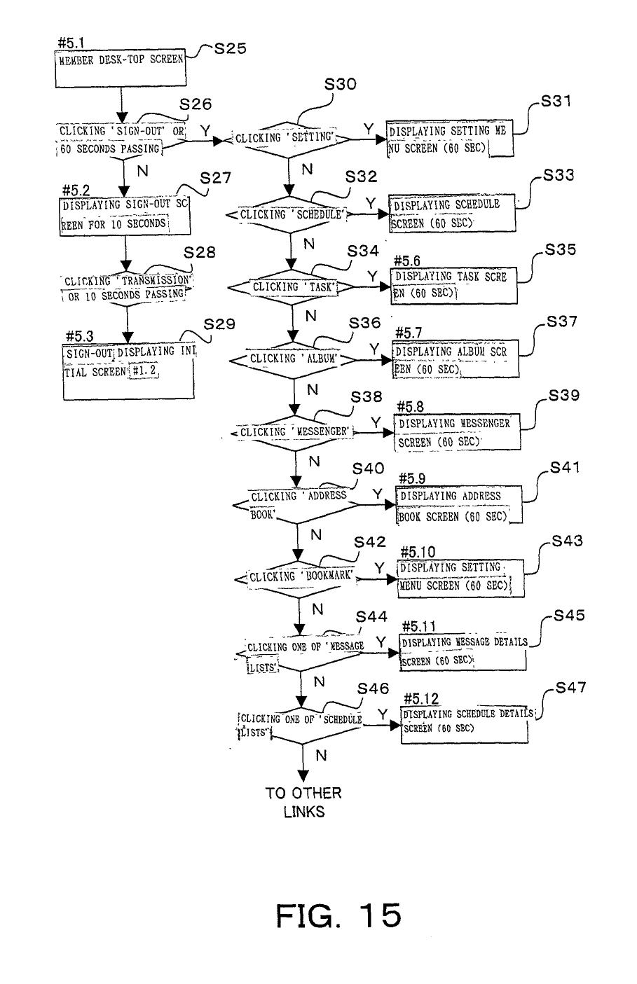

FIG. 15 is a flowchart of the subsequent processes. After displaying the top screen exclusive for the members, the ‘sign-out’ is determined (S26). If the sign-out is determined, then the corresponding sign-out process is performed (S27 through S29).

If ‘setting’ is clicked, a specified menu screen is displayed (N in S26, Y in S30, S31). The required time is 60 seconds. If ‘schedule’ shown in FIG. 14 is clicked (Y in S32), then the initial screen of the ‘schedule’ is displayed (S33). It is displayed for 60 seconds, and then control is returned to the above mentioned top screen exclusive for the members.

Similarly, when ‘task’ shown in FIG. 14 is clicked (Y in S34), then the initial screen of the ‘task’ is displayed (S35). After the screen is displayed for 60 seconds, control is returned to the above mentioned top screen exclusive for the members. Similarly, when ‘album’ is clicked, the initial screen of the ‘album’ is displayed (Y in S36, S37), and when ‘messenger’ is clicked, the initial screen of the ‘messenger’ is displayed Y in S38, S39).

Similarly, as shown in FIG. 15, the initial screen of each of an ‘address book’, a ‘bookmark’, a ‘message list’, and a ‘schedule list’ can be displayed by checking the corresponding button as shown in FIG. 15 (S40 through S47).

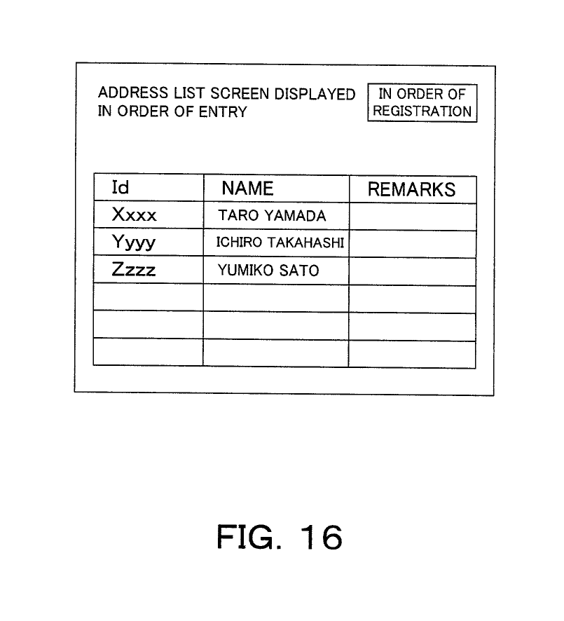

Then, FIG. 16 shows the case in which the above mentioned ‘address book’ is selected. First, the initial screen of the ‘address book’ shows the addresses in order of the previously displayed screen. Before the change is made in the present embodiment, the addresses are displayed in the order of entry or user ID. For example, by clicking the ‘entry order’ button shown in FIG. 16, the addresses are displayed in the order of entry. By clicking the ‘user ID order’ button shown in the entry order display but not shown in the attached drawings, they are displayed in the order of user ID.

As described above, the display shown in FIG. 16 is made in the order of the previous display, that is, the previous display history shows ‘Taro Yamada’, ‘Ichiro Takahashi’, and ‘Yumiko Sato’ in this order. In the database with the above mentioned configuration, names are input in kanji in most cases in Japan, and the names are arranged in the order of kanji code. Therefore, it is not easy to retrieve a name. As a result, in the present invention, a nickname column is added. That is, a name in kana or Roman characters can be input in the nickname column to display names in the order of nickname. This method is described below in detail.

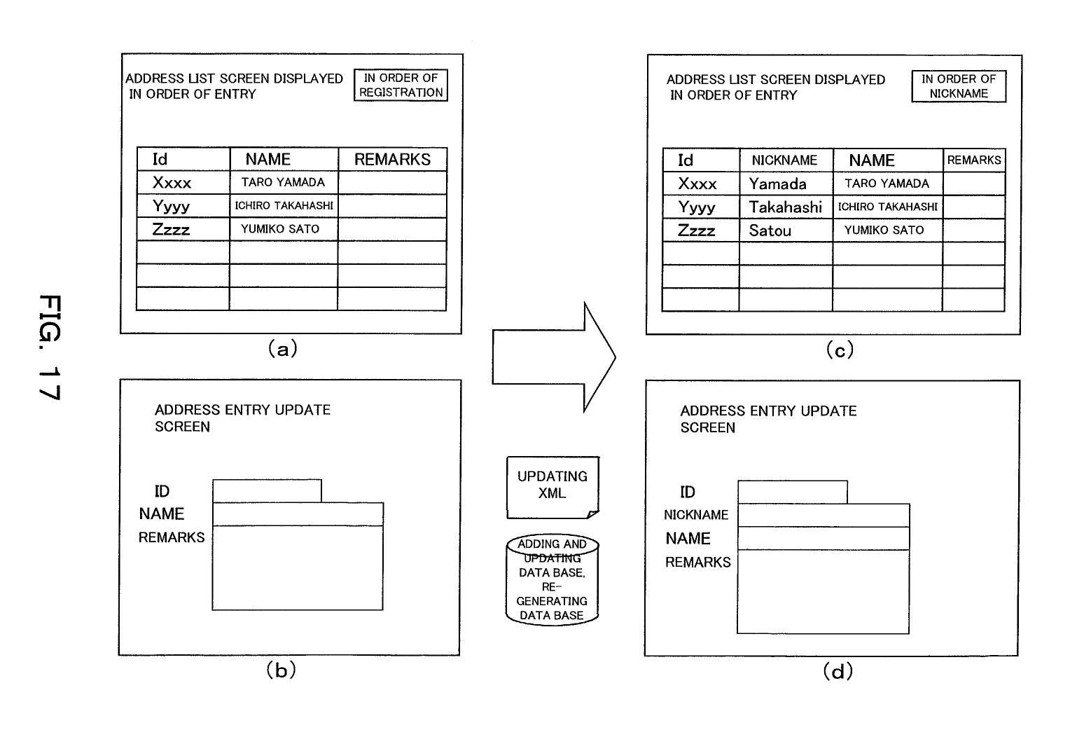

FIG. 17 shows a changed image of the ‘address book’ in the above mentioned case. FIG. 17(a) shows an example of an address list screen before the change shown in FIG. 16. FIG. 17(b) shows an example of the address entry update screen before the change. By referring to the figures, the XML document is changed, a nickname is added to the database, and the database is updated and re-generated.

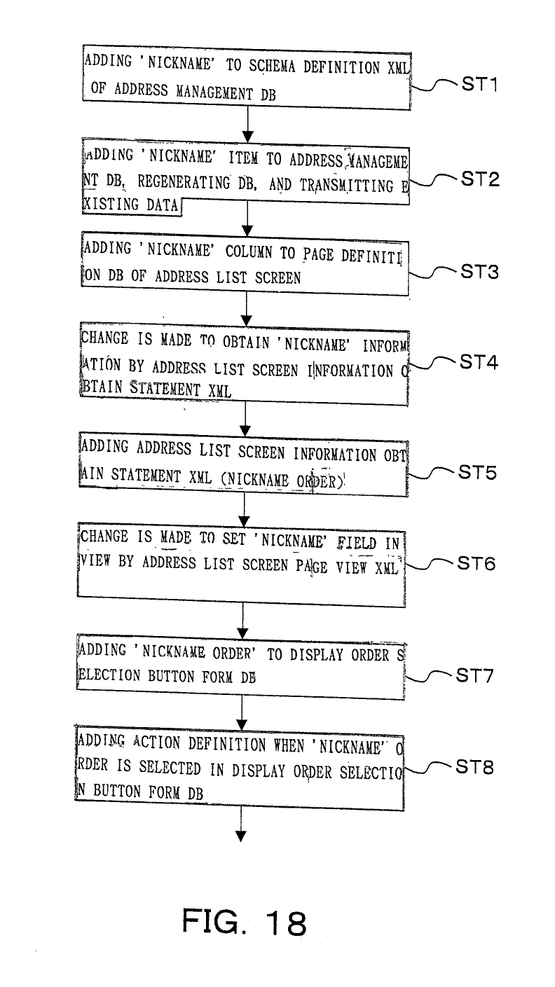

FIG. 18 is a flowchart of the process. For example, a function can be changed without changing the coding of a Java program. First, a ‘nickname’ is added to the schema definition XML (34 shown in FIG. 3, 71 shown in FIG. 4, and 64 shown in FIG. 6) of the address management database (step (hereinafter referred to ST) 1).

Then, a ‘nickname’ item is provided in the address management database to re-organize the database (ST 1). That is, a ‘nickname’ column is added to the page definition database on the address list screen (ST 3).

Then, a change is made to obtain ‘nickname’ information by an address list screen information obtain statement XML (33 shown in FIG. 3, 72 shown in FIG. 4, and 63 shown in FIG. 6) (ST 4). At this time, a change is made to obtain the ‘nickname’ information in the ‘entry order’, ‘user ID order’, and ‘name order’.

Next, the address list screen information obtain statement XML ‘nickname column’ is added (ST 5). Then, a change is made to set a ‘nickname’ field in the view by an address list screen page view XML (32 shown in FIG. 3, 37 shown in FIG. 4, and 42 shown in FIG. 5) (ST 6).

Then, a ‘nickname order’ button is added to the display order selection button form database (ST 7), and an action definition set when the ‘nickname order’ is selected in the display order selection button form database is added (ST 8).

Then, a ‘nickname’ input/output column is added to the page definition database of the address entry update screen (ST 9), and a change is made to obtain the ‘nickname’ information by the address information obtain statement XML (33 shown in FIG. 3, 72 shown in FIG. 4, and 63 shown in FIG. 6) (ST 10).

Then, a change is made to set a ‘nickname’ field in the view by the address entry update screen page view XML (32 shown in FIG. 3, 37 shown in FIG. 4, and 42 shown in FIG. 5) (ST 11), and to update the ‘nickname’ information by the address information entry update statement XML (33 shown in FIG. 3, 72 shown in FIG. 4, and 63 shown in FIG. 6) (ST 12).

Then, a change is made to enter the contents of the ‘nickname’ field in the address management database by the address information entry update action XML (31 shown in FIG. 3, 73 shown in FIG. 4, and 41 shown in FIG. 5) (ST 13).

In the above mentioned process, the address list screen shown in FIG. 17(c) is generated. For example, by checking the ‘nickname’ button, the display can be changed from the order of the previous display to the order of nickname. Therefore, addresses can be retrieved by a nickname, and the site can be set for easier retrieval. FIG. 17(d) shows an example of an address entry update screen after the change.

In the above mentioned embodiment, the example of ‘address information’ as shown in FIG. 17 has been described, but the present invention is not limited to the ‘address information’, and can be applied to various databases for ‘map information, ‘schedule’, ‘mail information’, etc. Therefore, the present invention can be applied to a PDA and a portable appliance such as a portable telephone, etc.

Since an XML document is used in the present embodiment, the contents of text are individually stored in a database, and a process of retrieving a character string can be easily performed over a plurality of applications.

In addition, by using a database (DB) editor, the settings of a page layout DB and a contents DB can be amended to immediately display the amended page information on a service window. Therefore, the page information DB can be maintained while confirming an amendment result.

In addition, using a logic editor, an XML document can be amended in real time, and the logic can be confirmed in a WS maintenance mode according to the amended XML document.

Furthermore, in the above mentioned pooling process according to the present embodiment, a necessary connection linking process is performed when a server is activated. Therefore, the response time can be substantially zero.

As described above, according to the Web suite system of the present invention, a database can be easily configured, data can be easily changed, and the contents and their layout can be easily changed.

Furthermore, the form of a generated page can be freely change, and the contents can be interactively provided.

What is claimed is:

1. A Web suite system, comprising:
a storing process of storing contents and page configuration information in a database;
a page data generating process of generating page data using the contents and the page configuration information stored in the database in said storing process; and
a display process of displaying the page data generated in said page data generating process on a user terminal device.

2. The system according to claim 1, wherein said contents include a character, an image, voice, and a binary code.

3. The system according to claim 1, wherein said page data is generated based on an XML document;

4. The system according to claim 1, wherein
said page data is generated by obtaining data from a database connected to a network.

5. The system according to claim 1, wherein
said terminal device is a PDA.

6. A Web suite server, comprising:
storage means for storing contents and page configuration information in a database; and
page data generation means for generating page data using the contents and the page configuration information stored in said storage means, wherein said page data generated by said page data generation means is provided by a user terminal device.

7. The server according to claim 6, wherein
said contents include a character, an image, voice, and a binary code.

8. The server according to claim 6, wherein
said page data is generated based on an XML document;

9. The server according to claim 6, wherein
said page data is generated by obtaining data from a database connected to a network.

10. The server according to claim 6, wherein
said terminal device is a PDA.

11. A computer-readable storage medium storing a program used to direct a computer to perform the functions of:
storing contents and page configuration information in a database;
generating page data using the contents and the page configuration information stored in the database by said storing function; and
transmitting the page data generated by said page data generating function to a user terminal device.
